(19) United States
(12) Patent Application Publication
(10) Pub. No.: US 2005/0182965 A1
(43) Pub. Date: Aug. 18, 2005

(54) Proxy permissions controlling access to computer resources

(75) Inventors: Jessica Murillo, Hutto, TX (US); Johnny Meng-Han Shieh, Austin, TX (US)

Correspondence Address: INTERNATIONAL BUSINESS MACHINES CORPORATION, c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY (US)

(21) Appl. No.: 10/777,718

(22) Filed: Feb. 12, 2004

(51) Int. Cl. H04L 9/00

(52) U.S. Cl. 713/201; 726/2

(57) ABSTRACT

Methods, systems, and products are disclosed for controlling access to a computer resource that include receiving from a requesting entity a request for access to the computer resource; determining that the requesting entity has a proxy permission, where the proxy permission has at least one associated proxy rule; and granting access to the computer resource in dependence upon the proxy rule. In typical embodiments, the proxy rule comprises at least one condition required for granting access to the computer resource. In typical embodiments, the condition has a plurality of possible states.

### BACKGROUND OF THE INVENTION

1. Field of the Invention

The field of the invention is data processing, or, more specifically, methods, systems, and products for controlling access to a computer resource.

2. Description of Related Art

Many operating systems and computer security systems control access to files, as well as and other computer resources, with permissions set for the owner of a file, one or more groups of users, and in some cases ‘other’ users, users who are neither an owner of a resource nor members of an authorized group. Some files require tight security, normally limiting access to a single user. Security control files and many configuration files ought to limit access to a single user or a very small group. For some files, even group permissions are too risky. There is well known problem, however, when the single authorized user is not available, ill, on vacation, traveling on business, and so on. In these cases, there is a risk that some useful action cannot be taken because no one available has permission to access a file. Other users sometimes ask a system administrator to override or take “root” control of a program or file and then perform a desired action. Often, however, even a system administrator is not available, and, even if a system administrator is available, circumventing computer resource security is not an efficient use of the administrator's time.

### SUMMARY OF THF INVENTION

Methods, systems, and products are disclosed for an authorized user to grant proxy permissions to access a computer resource to which another user would not otherwise have access. More particularly, methods, systems, and products are disclosed for controlling access to a computer resource that include receiving from a requesting entity a request for access to the computer resource; determining that the requesting entity has a proxy permission, where the proxy permission has at least one associated proxy rule; and granting access to the computer resource in dependence upon the proxy rule. In typical embodiments, the proxy rule comprises at least one condition required for granting access to the computer resource. In typical embodiments, the condition has a plurality of possible states.

In some embodiments, determining that the requesting entity has a proxy permission includes finding, in dependence upon a requesting entity identification, an access control entry in an access control list for the computer resource. In some embodiments, determining that the requesting entity has a proxy permission includes finding, in dependence upon a requesting entity identification, a proxy permission record in a proxy permission table. Some embodiments also include reading a proxy permission indicator from a data structure representing the resource. Some embodiments also include reading a proxy permission indicator from an access control list for the resource.

In typical embodiments, the proxy rule includes one or more conditions required for granting access to the computer resource and granting access to the computer resource based on the proxy rule may be carried out by determining whether the conditions of the proxy rule are met and permitting access to the computer resource if the conditions of the proxy rule are met. In typical embodiments, each condition has a plurality of possible states and granting access to the computer resource based on the proxy rule further comprises evaluating the states of the conditions.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a line drawing of a system architecture in accordance with which various exemplary embodiments of the present invention may be implemented.

FIG. 2 sets forth a block diagram of automated computing machinery comprising a computer useful according to various embodiments of the present invention.

FIG. 3 sets forth a flow chart illustrating a method for controlling access to a computer resource.

FIG. 4 sets forth a flow chart illustrating an exemplary method of determining that a requesting entity has a proxy permission.

### DETAILED DESCRIPTION OF EXEMPLARY EMBODIMENTS

### Introduction

The present invention is described to a large extent in this specification in terms of methods for controlling access to a computer resource. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### DETAILED DESCRIPTION

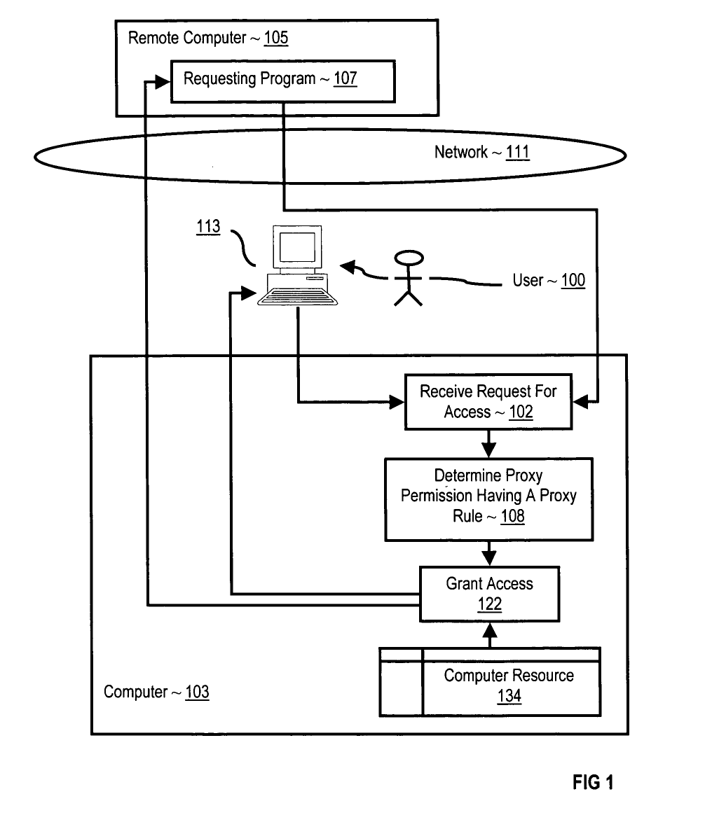

FIG. 1 sets forth a line drawing of a system architecture in accordance with which various exemplary embodiments of the present invention may be implemented. Embodiments of the present invention generally include methods, systems, and products for controlling access to a computer resource. As shown in FIG. 1, embodiments of the invention operate generally by receiving 102 from a requesting entity (100, 107) a request for access to a computer resource 134, determining 108 that the requesting entity has a proxy permission having at least one associated proxy rule, and granting 122 access to the computer resource in dependence upon the proxy rule.

Methods of the invention are concerned generally with authorization for access to a computer resource. A requesting entity can be anything, any person, program, process, or apparatus, capable of presenting a request for access to a computer resource. In terms of the architecture of FIG. 1, a requesting entity may be represented by a user 100 operating a personal computer or computer workstation 113 to request access to a file located on the personal computer itself or on an adjacent local area network (“LAN”). Alternatively, a requesting entity may be represented by a requesting program or computer process 107 running on a remote computer 105 connected for data communications across a network 111 to a computer 103 upon which is located a computer resource 134.

Requests for access to computer resources include any user control, computer instruction, or data communications protocol message that requests access to computer resources. Examples of types of requests for access to computer resources include:
requests to execute a computer program
requests to delete a file, directory, or other computer resource
requests to create a file, directory, or other computer resource
requests to read a file, directory, or other computer resource
requests to write to a file, directory, other computer resource
requests to search a directory, execute a file, or operate another computer resource

Examples of particular requests for access to computer resources include:
A word processor requests write access to a file.
A user operates a GUI or a CLI to request execution of a program.
A user operates a GUI or a CLI to request listing of a directory.
A browser request to a web server for an HTML file identified by a URL.
A browser request to a web server for execution of a CGI script identified by a URL.
An email client request to a POP server for an email message on the server.

In some examples a requesting entity may be considered a person, or at least a process of execution associated with a user. In some examples, a requesting entity is a security daemon, a search agent, a server process, or some other process of execution that operates independently of any association with any particular person.

“Resource” means any information or physical item access to which is controlled by methods, systems, or products according to the present invention. The most common kind of resource is a file, but resources include dynamically-generated query results, the output of CGI scripts, dynamic server pages, documents available in several languages, as well as physical objects such as garage doors, briefcases, and so on. Resources often comprise information in a form capable of being identified by a URI or URL. In fact, the ‘R’ in ‘URI’ is ‘Resource.’ It may therefore be useful to consider a resource as similar to a file, but more general in nature. Files as resources include web pages, graphic image files, video clip files, audio clip files, and so on. As a practical matter, most HTTP resources are currently either files or dynamic output from server side functionality. Server side functionality includes CGI programs, Java servlets, Active Server Pages, Java Server Pages, and so on.

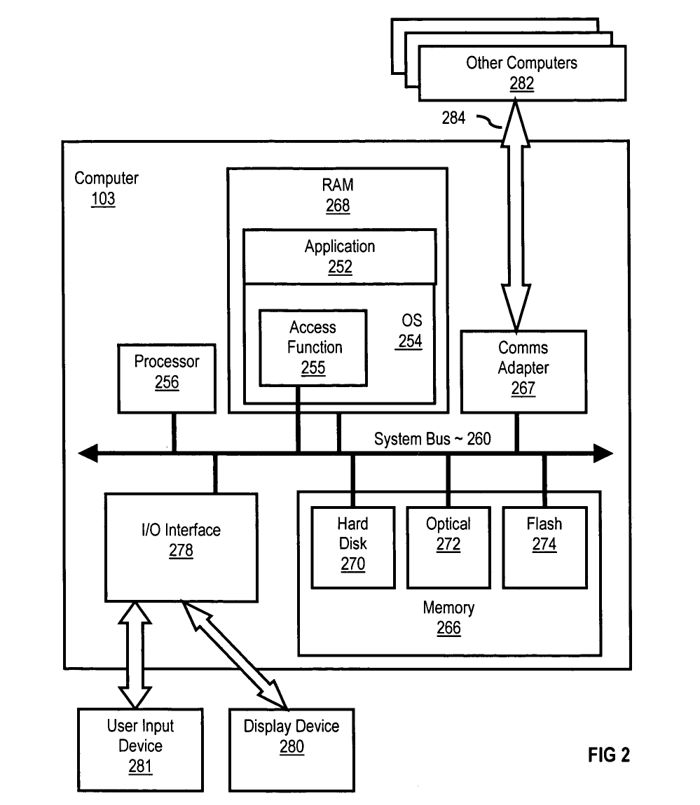

The term “computer,” in this specification, refers to any automated computing machinery. The term “computer” therefore includes not only general purpose computers such as laptops, personal computer, minicomputers, and mainframes, but also devices such as personal digital assistants (“PDAs), network enabled handheld devices, internet-enabled mobile telephones, and so on. For further explanation, FIG. 2 sets forth a block diagram of automated computing machinery comprising a computer (103) useful according to various embodiments of the present invention. The computer (103) of FIG. 2 includes at least one computer processor (256) or ‘CPU’ as well as random access memory (268) (“RAM”). Stored in RAM (268) is an application program (252). Application programs useful in accordance with various embodiments of the present invention include browsers, word processors, spreadsheets, database management systems, email clients, TCP/IP clients, and so on, as will occur to those of skill in the art. When computer (103) is operated as an email client, application (252) includes email client application software. When a computer like computer (103) is operated as a browser, application (252) includes browser application software. Examples of email application software include Microsoft's Outlook™, Qualcomm's Eudora™, and Lotus Notes™. Examples of browser application software include Microsoft Outlook™, Netware Netscape™, and NCSA Mosaic™.

Also stored in RAM (268) is an operating system (254). Operating systems useful in computers according to embodiments of the present invention include Unix, Linux™, Microsoft NT™, and others as will occur to those of skill in the art. Transport and network layer software clients such TCP/IP clients are typically provided as components of operating systems, including Microsoft Windows™, IBM's AIX™, Linux™, and so on. In the example of FIG. 2, operating system (254) also includes at least one security access control function (255) for use in controlling access to computer resources, user input devices (280), and display devices (280). Examples of display devices include GUI screens, text screens, touch sensitive screens, Braille displays, and so on. Examples of user input devices include mice, keyboards, numeric keypads, touch sensitive screens, microphones, and so on.

The example computer (103) of FIG. 2 includes computer memory (266) coupled through a system bus (260) to the processor (256) and to other components of the computer. Computer memory (266) may be implemented as a hard disk drive (270), optical disk drive (272), electrically erasable programmable read-only memory space (so-called ‘EEPROM’ or ‘Flash’ memory) (274), RAM drives (not shown), or as any other kind of computer memory as will occur to those of skill in the art. The example computer (103) of FIG. 2 includes communications adapter (267) that implements connections for data communications (284) to other computers (282). Communications adapters (267) implement the hardware level of data communications connections through which client computers and servers send data communications directly to one another and through networks. Examples of communications adapters (267) include modems for wired dial-up connections, Ethernet (IEEE 802.3) adapters for wired LAN connections, 802.11 adapters for wireless LAN connections, and Bluetooth adapters for wireless microLAN connections.

The example computer of FIG. 2 includes one or more input/output interface adapters (278). Input/output interface adapters (278) in computer (103) include hardware that implements user input/output to and from user input devices (281) and display devices (280). In the example of FIG. 2, applications (262) effect user-oriented input/output representing requests received through user input devices for access to computer resources controlled by operating system access functions (255) which may grant access to computer resources resulting in their return to requesters through display devices through one or more input/output interface adapters (278). In particular, an operating system function such as Unix's ‘chmod’ is an example of an access function (255) that controls access to a computer resource by affecting access permissions on files. Application software (252) and operating systems (254), including particularly access functions (255), may be altered to implement embodiments of the present invention by use of plug-ins, kernel extensions, or modifications at the source code level in accordance with embodiments of the present invention. A function such as ‘chmod,’ for example, that would ordinarily affect only the permissions on a file, may be improved according to embodiments of the present invention to also record proxy permissions and proxy rules. Alternatively, completely new applications or operating system software, including particularly access functions, may be developed from scratch to implement embodiments of the present invention. For example, rather than modifying ‘chmod,’ a developer of security access functions according to embodiments of the present invention may develop an entirely new access function called ‘chprox’ to create or change proxy permissions and proxy rules for files and other computer resources.

The following form of chmod command, for example:

chmod -p <proxy_user_id> -r/global_shared_directory/sysadmin/rules

/usr/bin/shutdown

may represent creation of a proxy permission for the user identified by <proxy_user_id> associated with a set of proxy rules located at “/global_shared_directory/sysadmin/rules” granting access permission or authority to access a computer resource. In this example, the computer resource is an executable file identified as “/usr/bin/shutdown.” The existence of the proxy permission may be represented in data by an entry on an operating system data structure (in Unix, an ‘inode’) representing the executable file. The data entry representing the existence of a proxy permission may be a Boolean entry or an asterisk, a numeric, a character, or a short string, as will occur to those of skill in the art. Alternatively, the inode may be left unaltered, and the existence of the proxy permission may be represented in data by an entry in an access control list (“ACL”) for the resource, the executable file identified as “/usr/bin/shutdown.” Alternatively, both the inode and the ACL for a resource may be left undisturbed, and the existence of a proxy permission may be represented in a totally separate data structure such as a proxy permissions table created for that purpose.

An ACL according to the present invention, for example, may include the data elements illustrated in Table 1:

TABLE 1
Examplary ACL Data Elements

| UserID | Permissions | Proxy Grantor | Rules |
|---|---|---|---|
| sue | r | | |
| john | r | | |
| melvin | rwe | | |
| nancy | * | sue | /sysadmin/rules |

Table 1 includes a column named “UserID” for storing a user identification of a user having permission to access a computer resource, a column named “Permissions” that identifies the scope of the permission, a column named “Proxy Grantor” identifying a proxy grantor if one exists, and a column named “Rules” identifying a ruleset for any proxy permissions represented in the table. The column identifying scope of permission is also used to indicate the existence of a proxy permission if there is one. More particularly, in this example, a user identified as “sue” is authorized to read the computer resource, a user identified as “john” is authorized to read the computer resource, a user identified as “melvin” is authorized to read, write, and execute the computer resource. The ‘*’ in the last record in Table 1 denotes the existence of a proxy permission. A user identified as “nancy” has a proxy permission granting sue's permissions if the rules in “/sysadmin/rules” are satisfied. It is useful to note that nancy does not necessarily have more permissions than sue. Nancy could be melvin's manager or sue's manager, who can make override decisions allowing sue access if melvin is not available.

Table 1 is used for explanation, but the actual data structure of an ACL has more detail than the structure of Table 1. An ACL is a list of Access Control Entries (“ACEs”). Each ACE defines a set of permissions for an individual user or for a group of users. An ACL provides precise control over who may access a file or directory and what access rights they have. The following is an example of a structure for an ACE that may be useful in controlling access to a computer resource according to embodiments of the present invention:

struct ACCESS_ALLOWED_PROXY_ACE
{

ACE_HEADER Header;
ACCESS_MASK Mask;
DWORD RequesterID;
STRING Grantor;
STRING RulesPointer;

}

ACCESS_ALLOWED_PROXY_ACE.Grantor is a string identifying a proxy grantor if one exists. ACCESS_ALLOWED_PROXY_ACE.RulesPointer is string containing the name of a ruleset for the proxy permissions granted according to the ACE. ACCESS_ALLOWED_PROXY_ACE.RequesterID identifies the memory storage location of a user identification for a requesting entity. ACE_HEADER is a structure that specifies the size and type of an ACE, such as, for example:

struct ACE_HEADER
{

BYTE AceType;
WORD AceSize;

}

The AceType member of the ACE_HEADER structure in this example may be set to ACCESS_ALLOWED_PROXY_ACE_TYPE, a new ACE type according to embodiments of the present invention. The AceSize member should be set to the total number of bytes allocated for the ACCESS_ALLOWED_PROXY_ACE structure.

ACCESS_ALLOWED_PROXY_ACE.Mask specifies an ACCESS_MASK structure that specifies the access rights granted by this ACE. Examples of access permissions that may be granted or denied in each ACE include:
permission to change an ACL
permission to delete a file, directory, or other computer resource
permission to create a file, directory, or other computer resource
permission to read a file, directory, or other computer resource
permission to write to a file, directory, other computer resource
permission to search a directory, execute a file, or operate another computer resource

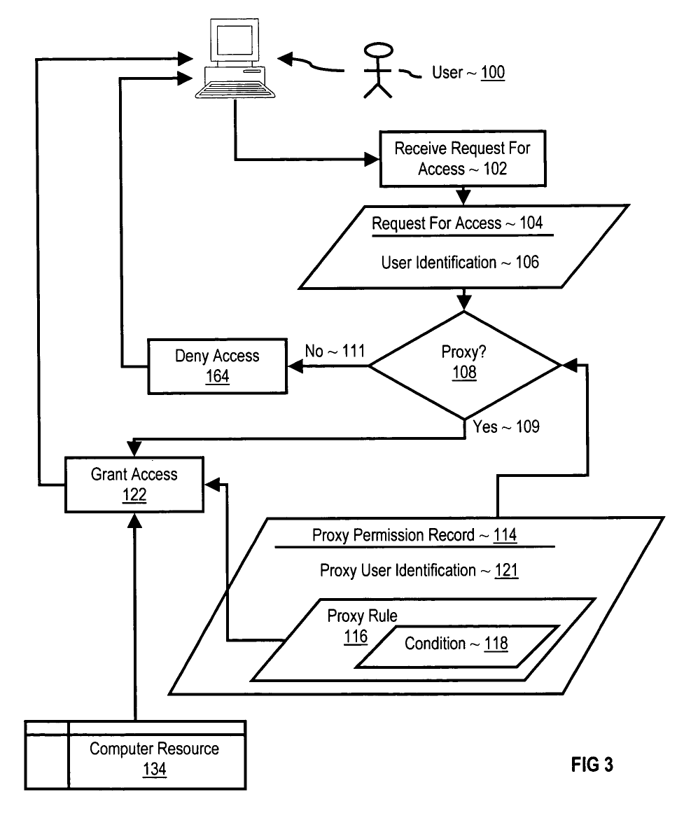

For further explanation, FIG. 3 sets forth a flow chart illustrating a method for controlling access to a computer resource 134 that includes receiving 102 from a requesting entity a request 104 for access to the computer resource 134. The example of FIG. 3, for purposes of explanation, includes a user 100 as a requesting entity, although a user as a requesting entity is not a limitation of the present invention. As previously defined, a requesting entity can be anything, any person, program, process, or apparatus, capable of presenting a request for access to a computer resource. In the method of FIG. 3, receiving 102 from a user 100 a request 104 for access to the computer resource 134 may be carried out by an operating system, or application programming, designed to receive a request 104 for access and retrieve from the request 104 a user identification 106 that is associated with the requesting entity.

In the exemplary method of FIG. 3, the request for access includes requesting entity user identification 106, as may occur when a security system requires that authentication information such as a Kerberos token accompany each request for access. A user identification can also be stored in a data structure representing a user login on a particular computer system or workstation on which a requesting entity is represented by a computational process, so that all requests for access received by an operating system or a security system from that process are inferred to be requests from the same requesting entity. Other ways to identify a requesting entity will occur to those of skill in the art, and all such ways are well within the scope of the present invention.

The method of FIG. 3 also includes determining 108 that the requesting entity has 109 a proxy permission 114. In the example of FIG. 3, a proxy permission record 114 represents the existence of a proxy permission. Determining 108 that the requesting entity has 109 a proxy permission therefore may be carried out by searching a database for a proxy permission record 114 that represents the existence of a proxy permission. In the example of FIG. 3, if there is no proxy permission record for a requesting entity 111, access to the computer resource is denied 164.

The method of FIG. 3 also includes granting 122 access to a computer resource 134 in dependence upon a proxy rule 116. In the example of FIG. 3, a proxy permission record 114 includes a proxy rule 116. In the method of FIG. 3, the proxy rule 116 comprises at least one condition required for granting 122 access to the computer resource 134. In the example of FIG. 3, granting access to a computer resource in dependence upon a proxy rule may be carried out by determining whether all the conditions for at least one proxy rule are satisfied. In such an example, when all the conditions for a rule are satisfied, the rule is considered satisfied. Consider an example of a rule named “Rule 1” having the following conditions:
Rule 1:
   condition 1: day of the week is Saturday
   condition 2: phase of the moon is Full

A computer security system programmed to grant access to a computer resource in accordance with embodiments of the present invention may proceed by determining whether the day of the week is Saturday and, if it is, proceeding further by determining whether the phase of the moon is Full. If the day of the week is Saturday and the phase of the moon is full, then Rule 1 is considered satisfied.

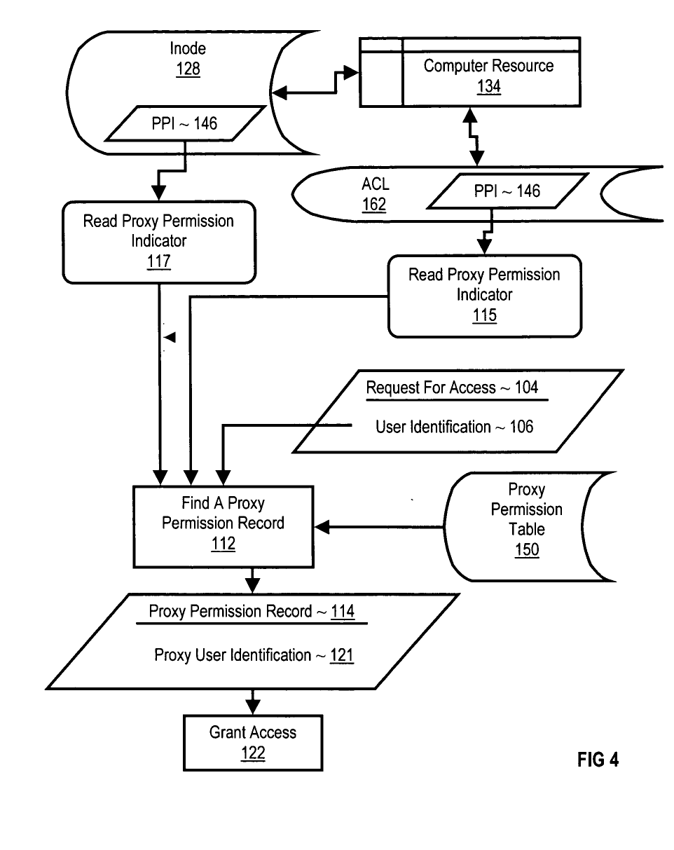

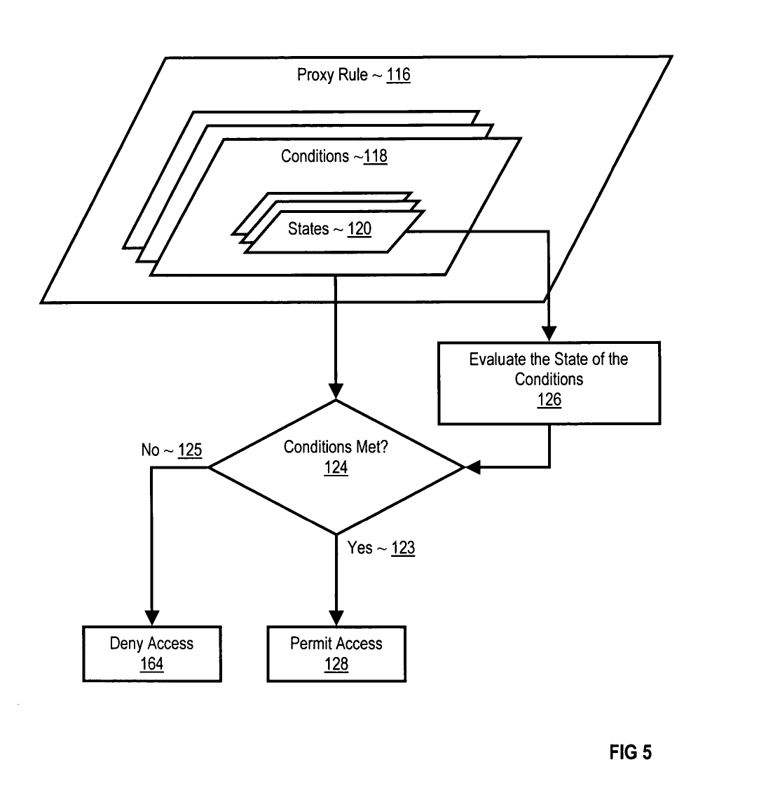

FIG. 4 sets forth a flow chart illustrating an exemplary method of determining (108 on FIG. 3) that the requesting entity has a proxy permission. The method in FIG. 4 includes finding 112 a proxy permission record 160 in a proxy permission table 150 in dependence upon the user identification 106. In this exemplary method, finding 112 a proxy permission record 114 from the proxy permission table 150 is accomplished by searching the proxy permission table for a proxy permission record with a field that contains a proxy user identification 121 that corresponds with the requesting entity's user identification 106. The finding of a proxy permission record that contains a proxy user identification 121 that corresponds with the requesting entity's user identification indicates that the requesting entity has a proxy permission.

A proxy permissions table according to the present invention, may, for example, include the data elements illustrated in Table 2:

TABLE 2
Proxy Permissions Table

| RequesterID | Grantor | Scope | Permissions | Rules |
|---|---|---|---|---|
| doug | pete | \usr\pete\*.doc | r | \shared\rules\122 |
| brian | pete | \usr\pete\*.exe | e | \shared\rules\125 |
| leslie | stacy | \usr\stacy\ | rw | \shared\rules\129 |
| | | newsletter.doc | | |
| nancy | stacy | \usr\stacy\*.db | rw | \shared\rules\212 |

Table 2 includes a proxy permissions table with a column named “RequesterID” that stores user identifications for requesting entities, a column named “Grantor” that stores identifications of users granting proxy permissions to requesting entities, a column named “Scope” that identifies computer resources to which access is granted through proxy permissions, a column entitled “Permissions” that lists the proxy permission granted to the requesting entity, and a column entitled “Rules” that points to files containing proxy rules for the proxy permissions.

Table 2 depicts the existence of proxy permission for read access granted by a user named “pete” to a user named “doug” for all the word processing files in \usr\pete\ if the rules in \shared\rules\122 are satisfied. Similarly in Table 2, “pete” grants “brian” proxy permission for execute access for all the executables in \usr\pete\ if the rules in \shared\rules\125 are satisfied. “Stacy” grants proxy permissions to “leslie” for read/write access to a word processing document having pathname \usr\stacy\newletter.doc if the rules in \shared\rules\129 are satisfied. And “stacy” grants proxy permission to “nancy” for read/write access to all the database files in \usr\stacy\.

The example of FIG. 4 includes two alternative methods (117, 115) of reading proxy permission indicators. The method of FIG. 4 includes a first alternative way of reading a proxy permission indicator 146 that is reading 117 a proxy permission indicator from a data structure 128 representing a computer resource 134. In the method of FIG. 4, the data structure representing a computer resource depicted is an inode. The use of an inode as a data structure representing a computer resource is not a limitation of the present invention. An inode is a data structure often used in Unix operating systems to represent computer resources. In WindowsNT™ data structures representing computer resources are often implemented as entries in a Master File Table (“MFT”). In MSDOS, a data structure representing a computer resource may be an entry in a File Access Table (“FAT”). The use of any data structure to represent a computer resource, as will occur to those of skill in the art, is well within the scope of the present invention.

In the method of FIG. 4, a flag or marker in a field in the inode (or other data structure representing a computer resource) can be a proxy permission indicator 146. The proxy permission indicator can be any data adapted to represent the existence of a proxy permission, including for example, an integer value, a Boolean flag, a special character such as a asterisk, and so on, as will occur to those of skill in the art.

The method of FIG. 4 includes a second alternative method of reading a proxy permission indicator that is reading 115 the proxy permission indicator from an ACL 162 for the computer resource. The indication of the existence of a proxy permission in an ACL is the presence in the ACL of an ACE allowing proxy access, such as, for example, an ACE fashioned according to the following structure:

struct ACCESS_ALLOWED_PROXY_ACE
{

ACE_HEADER Header;
ACCESS_MASK Mask;
DWORD RequesterID;
Boolean ProxyPermissionExists;

}

In this example, reading 115 a proxy indication from an ACL may be carried out by scanning through the ACEs of an ACL looking for one that allows proxy permissions for a user whose identification matches the contents of ACCESS_ALLOWED_PROXY_ACE.RequesterID. Processing then may proceed by looking up a proxy permission record for the user identified as “RequesterID” in a proxy permission table of the kind illustrated in Table 2.

As mentioned above, FIG. 4 sets forth a flow chart illustrating an exemplary method of determining (108 on FIG. 3) that the requesting entity has a proxy permission. A further alternative method of determining that a requesting entity has a proxy permission, not shown in FIG. 4, is to scan through an ACL to find a proxy allowing ACE of the kind first described above:

struct ACCESS_ALLOWED_PROXY_ACE
{

ACE_HEADER Header;
ACCESS_MASK Mask;
DWORD RequesterID;
STRING Grantor;
STRING RulesPointer;

}

In this example, the fact that such an ACE is present in the ACL denotes the existence of a proxy permission for the requesting entity identified in ACCESS_ALLOWED_PROXY_ACE.RequesterID.

FIG. 5 sets forth a flow chart illustrating an exemplary method of granting (122 on FIG. 3) access to a computer resource in which a proxy rule 116 includes one or more conditions 118 required for granting 122 access to the computer resource 134. In the method of FIG. 5, granting access to the computer resource (134) based on the proxy rule 116 is carried out by determining 124 whether the conditions 118 of the proxy rule 116 are met 123 and permitting 128 access to the computer resource 134 if the conditions 118 of the proxy rule 116 are met 123.

In the example of FIG. 5, each condition 118 has a plurality of possible states 120 and granting access to the computer resource based on a proxy rule includes evaluating 126 the states 120 of the conditions 118. For each condition in a proxy rule, at least one state of the condition satisfies the condition. Consider the exemplary condition, “The day is not a weekday.” “Day” has seven possible states, Monday through Sunday, and two of those states, Saturday and Sunday, satisfy the condition.

For further explanation, consider the following set of exemplary proxy rules:
Rule 1:
   Condition 1: The day is not a weekday.
Rule 2:
   Condition 1: The system administrator is on vacation.
Rule 3:
   Condition 1: Time is between 9 p.m. and 11:59 p.m.
   Condition 2: Date is January 10.

Rule 1 has one condition having seven possible states, two of which satisfy the condition. Rule 2 has one condition having two possible states (ON-VACATION and NOT-ON-VACATION), one of which satisfies the condition. Rule 3 has two conditions. Condition 1 of Rule 3 has two possible states (either the time is in the range or not), one of which satisfies the condition. Condition 2 of Rule 3 has two possible states (January 10 or not), one of which satisfies the condition.

For further explanation, consider the following set of exemplary proxy rules:
Rule 1:
   Condition 1: Resource owner is not logged on.
   Condition 2: Resource owner last logon was more than 10 days ago.
Rule 2:
   Condition 1: Resource owner calendar status is ON-VACATION.

Rule 1 in this example has two conditions. Condition 1 of Rule 1 has two possible states (the resource owner is either logged on or not), one of which satisfies the condition. Condition 2 of Rule 1 has two possible states (the resource owner either has logged on in the last ten days or not), one of which satisfies the condition. Evaluating 126 the states 120 of the conditions 118 of Rule 1 includes querying operating system records of resource ownership and logon times. Rule 2 in this example has one condition having two possible states (ON-VACATION and NOT-ON-VACATION), one of which satisfies the condition. Evaluating 126 the states 120 of the conditions 118 of Rule 2 includes querying operating system records of resource ownership and querying a calendaring application for the calendar status of the resource owner.

For further explanation, consider the following set of exemplary proxy rules:
Rule 1:
   Condition 1: No user with non-proxy permissions is logged.
   Condition 2: No user with non-proxy permissions is not on vacation.

Rule 1 in this example has two conditions. Condition 1 of Rule 1 has two possible states (some user with non-proxy permissions is either logged on or not), one of which satisfies the condition. Condition 2 of Rule 1 has two possible states (at least one user with non-proxy permissions is not on vacation or not), one of which satisfies the condition. Evaluating 126 the states 120 of condition 1 of Rule 1 includes querying operating system records regarding current logons for all users having non-proxy permissions. Users having non-proxy permissions may be identified by querying an ACL for the resource for all non-proxy ACEs. Evaluating 126 the states 120 of condition 2 of Rule 1 includes querying operating system records of non-proxy permissions for the resource as well as querying a calendaring application for the calendar status of all users with non-proxy permissions for the resource.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for controlling access to a computer resource, the method comprising:
receiving from a requesting entity a request for access to the computer resource;
determining that the requesting entity has a proxy permission, wherein the proxy permission has at least one associated proxy rule; and
granting access to the computer resource in dependence upon the proxy rule.

2. The method of claim 1 wherein the proxy rule comprises at least one condition required for granting access to the computer resource.

3. The method of claim 2 wherein the condition has a plurality of possible states.

4. The method of claim 1 wherein determining that the requesting entity has a proxy permission further comprises finding, in dependence upon a requesting entity identification, an access control entry in an access control list for the computer resource.

5. The method of claim 1 wherein determining that the requesting entity has a proxy permission further comprises finding, in dependence upon a requesting entity identification, a proxy permission record in a proxy permission table.

6. The method of claim 5 further comprising reading a proxy permission indicator from a data structure representing the resource.

7. The method of claim 5 further comprising reading a proxy permission indicator from an access control list for the resource.

8. The method of claim 1 wherein the proxy rule comprises one or more conditions required for granting access to the computer resource and granting access to the computer resource based on the proxy rule further comprises:
determining whether the conditions of the proxy rule are met; and
permitting access to the computer resource if the conditions of the proxy rule are met.

9. The method of claim 8 wherein each condition has a plurality of possible states and granting access to the computer resource based on the proxy rule further comprises evaluating the states of the conditions.

10. A system for controlling access to a computer resource, the system comprising:
means for receiving from a requesting entity a request for access to the computer resource;
means for determining that the requesting entity has a proxy permission, wherein the proxy permission has at least one associated proxy rule; and
means for granting access to the computer resource in dependence upon the proxy rule.

11. The system of claim 10 wherein the proxy rule comprises at least one condition required for granting access to the computer resource.

12. The system of claim 11 wherein the condition has a plurality of possible states.

13. The system of claim 10 wherein means for determining that the requesting entity has a proxy permission further comprises means for finding, in dependence upon a requesting entity identification, an access control entry in an access control list for the computer resource.

14. The system of claim 10 wherein means for determining that the requesting entity has a proxy permission further comprises means for finding, in dependence upon a requesting entity identification, a proxy permission record in a proxy permission table.

15. The system of claim 14 further comprising means for reading a proxy permission indicator from a data structure representing the resource.

16. The system of claim 14 further comprising means for reading a proxy permission indicator from an access control list for the resource.

17. The system of claim 10 wherein the proxy rule comprises one or more conditions required for granting access to the computer resource and means for granting access to the computer resource based on the proxy rule further comprises:
means for determining whether the conditions of the proxy rule are met; and
means for permitting access to the computer resource if the conditions of the proxy rule are met.

18. The system of claim 17 wherein each condition has a plurality of possible states and means for granting access to the computer resource based on the proxy rule further comprises means for evaluating the states of the conditions.

19. A computer program product for controlling access to a computer resource, the computer program product comprising:
a recording medium;
means, recorded on the recording medium, for receiving from a requesting entity a request for access to the computer resource;
means, recorded on the recording medium, for determining that the requesting entity has a proxy permission, wherein the proxy permission has at least one associated proxy rule; and
means, recorded on the recording medium, for granting access to the computer resource in dependence upon the proxy rule.

20. The computer program product of claim 19 wherein the proxy rule comprises at least one condition required for granting access to the computer resource.

21. The computer program product of claim 20 wherein the condition has a plurality of possible states.

22. The computer program product of claim 19 wherein means, recorded on the recording medium, for determining that the requesting entity has a proxy permission further comprises means, recorded on the recording medium, for finding, in dependence upon a requesting entity identification, an access control entry in an access control list for the computer resource.

23. The computer program product of claim 19 wherein means, recorded on the recording medium, for determining that the requesting entity has a proxy permission further comprises means, recorded on the recording medium, for finding, in dependence upon a requesting entity identification, a proxy permission record in a proxy permission table.

24. The computer program product of claim 23 further comprising means, recorded on the recording medium, for reading a proxy permission indicator from a data structure representing the resource.

25. The computer program product of claim 23 further comprising means, recorded on the recording medium, for reading a proxy permission indicator from an access control list for the resource.

26. The computer program product of claim 19 wherein the proxy rule comprises one or more conditions required for granting access to the computer resource and means, recorded on the recording medium, for granting access to the computer resource based on the proxy rule further comprises:
means, recorded on the recording medium, for determining whether the conditions of the proxy rule are met; and means, recorded on the recording medium, for permitting access to the computer resource if the conditions of the proxy rule are met.

27. The computer program product of claim 26 wherein each condition has a plurality of possible states and means, recorded on the recording medium, for granting access to the computer resource based on the proxy rule further comprises means, recorded on the recording medium, for evaluating the states of the conditions.
